(19) United States
(12) Patent Application Publication
(10) Pub. No.: US 2009/0157668 A1
(43) Pub. Date: Jun. 18, 2009

(54) METHOD AND SYSTEM FOR MEASURING AN IMPACT OF VARIOUS CATEGORIES OF MEDIA OWNERS ON A CORPORATE BRAND

(76) Inventors: Christopher Daniel NEWTON, Fredericton (CA); Marcel Albert LEBRUN, Fredericton (CA); Christopher Bennett RAMSEY, Fredericton (CA)

Correspondence Address: VICTORIA DONNELLY, PO BOX 24001, HAZELDEAN RPO, KANATA, ON, K2M 2C3, CA

(21) Appl. No.: 12/333,277

(22) Filed: Dec. 11, 2008

Related U.S. Application Data
(60) Provisional application No. 61/013,242, filed on Dec. 12, 2007.

(51) Int. Cl. G06F 7/06; G06F 17/30

(52) U.S. Cl. 707/5; 707/E17.108

(57) ABSTRACT

A method and system for determining influence of various categories of content sources on a selected brand is disclosed. The method defines a brand profile using terms and URLs associated with the selected brand and queries popular search engines using the terms and URLs as search terms. The results are classified according to their category of content sources and a brand ownership score is calculated from the classified results and from other weights associated to the ranks of the results, to the category of content sources and to the search engines. The category of content sources having ownership of the selected brand is then identified from the brand ownership score.

### RELATED APPLICATIONS

The present application claims benefit from the U.S. provisional application to Christopher NEWTON Ser. No. 61/013,242 filed on Dec. 12, 2007 entitled “A Method And System For Measuring An Impact Of Various Categories Of Media Owners On A Corporate Brand”, and the U.S. patent application to Christopher NEWTON Ser. No. 12/174,345 filed on Jul. 16, 2008 entitled “Method and System for Determining Topical On-line Influence of an Entity”, both of which are incorporated herein by reference.

### FIELD OF INVENTION

The present patent application relates to a computer implemented method and system for determining influence of various categories of media, and in particular social media, on a corporate brand.

### BACKGROUND OF THE INVENTION

The rise of social media, for example, socially connected consumer generated media, has affected how brands are perceived and how marketers and brand owners work with the brand. The perception of a brand by consumers was once in the control of brand owners, and largely the result of marketing and advertising campaigns. Those days are gone now as people move away from traditional media sources such as TV, newspapers and magazines. Further, the entire generation of youth, referred to as digital natives, has been raised, who have been growing up with the Internet and digital devices and content on demand, and having almost no connection to newspapers, magazines and limited use of television. For these people, the image of a brand in their mind is almost completely formed by what they see online. Specifically, search engines play a key role in this regard.

When a user looks for information on a brand or product online they will use search engines. Depending on what communities and interests the user has, they may use a variety of search engines, which cover various segments of content. For instance, they may use Blog search engines to find content from bloggers about the product. They may use the search abilities on their favorite video content provider, such as YouTube, to look for user reviews of the product. They may search Flickr or other similar image search engines to find product pictures by people who have bought them. They may also use Google search, Yahoo and other search engines to find text reviews.

In every case, the order of search results returned to the user has a profound effect on the user's view of a brand. It is widely known that the percentage of users who proceed to click through past the first few pages of search results obtained from a search engine is very small. Because of this, the search results returned in those first few pages are critical to the formation of a brand in the eyes of a user.

Importantly then, it is clear that the one who owns the search results returned on the first few pages across most popular search engines is largely in control of the brand. This fact has been known to the experts in the field of brand management and public relations (PR), and has been discussed openly in recent years.

However, it has been unknown how to measure the breakdown of brand ownership for individual clients.

If mainstream media links dominate in the search results returned by search engines for a particular brand, then that brand can be considered to be ‘owned’ by mainstream media. If the search results return by search engines are largely related to press releases, links or websites of the brand owner, then the brand owner owns the voice of the brand on the Internet.

If, however, the search results returned by search engines are largely represented by community driven sites and social media content, then the brand can be considered to be owned by the community. In this case, the brand heavily depends on views and content generated by consumers and not the company, which owns the brand, and not by mainstream media. Therefore the social media for this brand becomes a very important component for the brand.

Search engine optimization companies and reputation management companies have been offering certain classifications of the search results by using sentiment analysis of the results to determine if they are positive or negative for the brand. However, it does not categorize or measure the extent to which others own the brand.

Accordingly, there is a need in the industry for the development of methods and system for determining a measure of the impact of the social media on a brand as a whole.

### SUMMARY OF THE INVENTION

Accordingly, there is an object of this invention to provide a method and system, which would allow companies to measure and understand the impact social media, or other categories of media owners or content sources, on their brands. With this measure, a company can assess the impact and trend, which social media has on the brand, and determine what possible business outcomes stem from this.

The method and system of the embodiment of the present invention provide a measure, which can gauge the distribution of content and how it changes over time to determine how the search results across popular search engines are distributed in the following categories of content sources:
Mainstream media content;
Brand-owned content;
Social media or community-owned content;
Spam content;
Third party content.

The higher the percentage of content, which is classified as ‘Community Owned’, the more the image of the brand is owned by the community, and the less that brand is in control.

In one aspect of the present invention, a method for determining a brand ownership is disclosed. The method comprises:

(a) generating a brand profile having one or more entries associated with the brand;

(b) querying one or more search engines with the one or more entries;

(c) retrieving a predetermined number of search results from each of said one or more search engines queried;

(d) classifying the search results by assigning each result to a category of content sources; and

(e) determining a brand ownership score of the selected brand based on said classified results.

Additionally, the step of generating the brand profile comprises:
i) generating a list of terms associated with said brand;
ii) generating a list of content sources associated with said brand; and
iii) storing the list of terms and the list of content sources in a database.

The step of calculating the brand ownership score further comprises representing the brand ownership score as an array of values, each value corresponding to an impact of a respective category of content sources on the brand.

In a modification to the method, the impact of the respective category of content sources is determined by:
i) assigning a weight to the respective category of content sources;
ii) calculating a number of search results classified under the respective category of content sources; and
iii) determining the impact based on the assigned weight, a number of search results classified under the respective category of content sources, a total number of search engines queried, and a total number of entries in the brand profile.

In another modification to the method, the impact of the respective category of content sources is determined by:
i) assigning a weight to the respective category of content sources;
ii) assigning a rank weight to each search result, classified under the respective category of content sources, the rank weight corresponding to a rank of the result; and
iii) determining the impact based on the assigned weight, the assigned rank weights, a total number of search engines queried, and a total number of entries in the brand profile.

In a further modification to the method, the impact of the respective category of content sources is determined by:
i) assigning a weight to the respective category of content sources;
ii) assigning a rank weight to each search result, classified under the respective category of content sources, the rank weight corresponding to a rank of the result;
iii) assigning a weight to each of said one or more search engines; and
iv) determining the impact based on the assigned weight, the assigned rank weights, a total number of search engines queried, a total number of entries in the brand profile, and the assigned weights of the one or more search engines.

Furthermore, the method further comprises identifying the category of content sources having ownership of the selected brand as the category of content sources having a highest value of the impact in the array of values.

Advantageously, the category of content source is selected from the group consisting of: mainstream media content category, spam content category, social media content category, third-party content category and brand content category.

In another aspect of the invention, a method of determining a brand ownership of a brand is provided, the method comprising:
(a) providing a brand profile for the brand, wherein the brand profile has one or more entries representing terms and content sources associated with the brand;
(b) querying one or more search engines with the one or more entries;
(c) for each of said one or more search engines queried, retrieving a predetermined number of search results, and classifying each search result under a category of content sources selected from the group consisting of: mainstream media content category, spam content category, social media content category, third-party content category and brand content category; and
(d) determining an impact value of each category of content sources on the selected brand based on a number of results classified under each respective category of content sources.

The method further comprises the step of identifying one category of content sources having a highest impact value as having ownership of the selected brand.

Additionally, the step (d) comprises:
i) assigning a weight to each category of content sources; and
ii) calculating the impact value based on the assigned weight, the number of search results classified under the respective category of content sources, a total number of search engines queried, and a total number of entries in the brand profile.

In a modification to the method, the step (d) comprises:
i) assigning a weight to the respective category of content sources;
ii) assigning a rank weight to each search result classified under the respective category of content sources, the rank weight corresponding to the rank of the search result; and
iii) calculating the impact value based on the assigned weight, the assigned rank weights, a total number of search engines queried, and a total number of entries in the brand profile.

In another modification to the method, the step (d) comprises:
i) assigning a weight to the respective category of content sources;
ii) assigning a rank weight to each search result classified under the respective category of content sources, the rank weight corresponding to the rank of the search result;
iii) assigning a weight to each of said one or more search engines; and
iv) calculating the impact value based on the assigned weight, the assigned rank weights, a total number of search engines queried, a total number of entries in the brand profile, and the assigned weights of the one or more search engines.

In yet another aspect of the present invention, a system for determining a brand ownership is disclosed, the system comprising:
a database, stored in a computer readable storage medium, for storing a profile of a brand, the database having one or more entries associated with the brand;
a computer, having a processor and a computer readable storage medium storing computer readable instructions for execution by the processor, to form the following modules:
a search engine interface for launching searches to one or more search engines using the one or more entries as search terms and retrieving search results returned by the one or more search engines;
a classification engine for classifying the search results retrieved by the search engine interface into a category of content sources; and
a brand ownership score calculation engine for determining a brand ownership score and identifying a category of content sources as having ownership of the brand based on the brand ownership score.

Advantageously, each search result is classified under a category of content sources selected from the group consisting of: mainstream media content category, spam content category, social media content category, third-party content category and brand content category;

Additionally, the one or more entries of the database comprise a list of one or more terms associated with the selected brand, and a list of one or more content sources associated with the selected brand.

In a modification of the system, the brand ownership score is an array of impact values, each impact value corresponding to a measure of impact of a respective category of content sources.

In a further modification to the system, each impact value of the respective category of content sources is calculated based on a weight associated to the respective category of content sources, and on a number of search results classified under the respective category of content sources.

In another modification to the system, each impact value of the respective category of content sources is calculated based on a weight associated to the respective category of content sources, on a number of search results classified under the respective category of content sources, and on respective rank weights assigned to each of said search results.

In yet another modification to the system, each impact value of the respective category of content sources is calculated based on a weight associated to said respective category of content sources, on a number of search results classified under the respective category of content sources, on respective rank weights assigned to each of said search results, and on respective weights assigned to said one or more search engines.

In yet a further aspect of the present invention, there is disclosed a computer readable medium, comprising a computer code instructions stored thereon, which, when executed by a computer, perform the steps of the methods of the embodiments of the present invention.

### BRIEF DESCRIPTION OF THE DRAWINGS

Embodiments of the invention will now be described, by way of example, with reference to the accompanying drawings, in which:

FIG. 1 shows a block diagram illustrating a brand ownership determination system according to the embodiment of the present invention;

FIG. 2 shows a block diagram of a brand ownership scoring module of FIG. 1;

FIG. 3 shows a flowchart illustrating a method for determining a brand ownership score;

FIG. 4 shows a table illustrating classified search results for a first entry;

FIG. 5 shows a table illustrating classified search results for a second entry; and

FIG. 6 shows a table illustrating an assignment of rank weights to search results.

### DETAILED DESCRIPTION OF THE EMBODIMENTS OF THE INVENTION

The method and system of the embodiment of the present invention provide a measure that can gauge the distribution of content among categories of content sources and track its changes over time to determine how the search results across popular search engines are distributed amongst the categories of content sources.

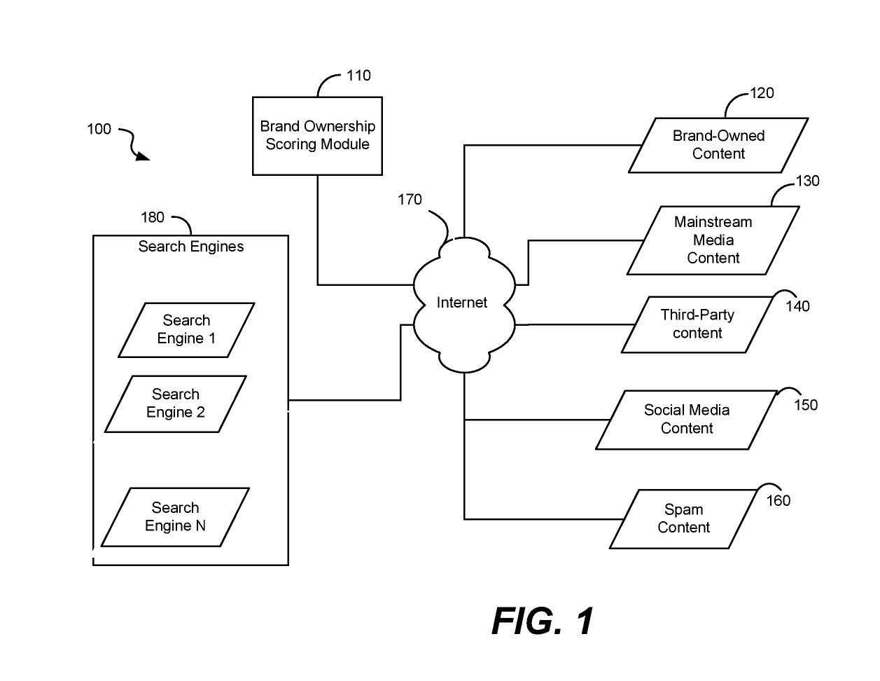

FIG. 1 shows a system of the embodiment of the present invention, comprising a Brand Ownership Scoring Module 110, which is interconnected through a network, such as the Internet 170, to a set of search engines 180 and to different categories of content sources 120 to 160.

The categories of content sources include Brand-owned content 120, Mainstream media content 130, Third-Party content 140, Social Media content 150 and Spam content 160.

The Brand-owned content 120 represents the content originating from online properties, such as websites maintained or owned by the organization or company, to which the brand is registered.

The Mainstream media content 130 represents the content originating from mainstream media news producers such as “New York Times”, “La Gazette”, “La Presse”, “Canadian Broadcasting Corporation” and any other video-based, text-based and audio-based online news producers. In the embodiment of the present invention, an aggregate list of online mainstream media news outlets maintained by a third party is accessible by the Brand Ownership Scoring Module 110.

The Social media content 150 represents the content from online communities, such as blogs, forums, and social networking sites, e.g., Facebook, Flickr, Classmates.com, etc. A social media monitoring service can maintain and update lists of social media sites, which can be accessible by the Brand Ownership Scoring Module 110.

The Spam content 160 represents the content tagged as spam, for example, this type of content can be identified by commercially available spam filters. In the embodiment of the present invention, the Brand Ownership Scoring Module 110 has access to a list of content or sites tagged as spam.

The Third-Party content 140 includes any remaining content, which has not been categorized into Brand owned content 120, Mainstream media content 140, Social media content 150 or Spam content 160.

The set of search engines 180 (Search Engine 1, Search Engine 2, . . . , Search Engine N) includes popular search engines, such as Yahoo, Google, Live Search, Altavista, etc. These search engines are well known to the average Internet user.

In the embodiment of the present invention, the Brand Ownership Scoring module 110 calculates a brand ownership score to determine which category of content sources has more impact on the brand, i.e. owns the brand.

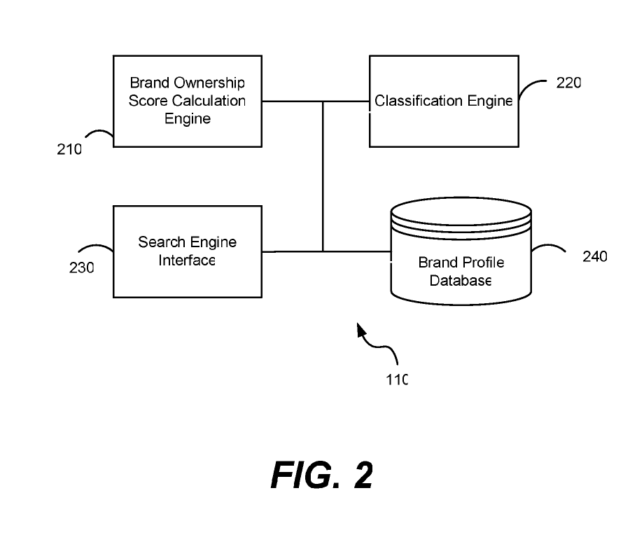

A block diagram of the Brand Ownership Scoring Module 110 is shown in FIG. 2, and will now be described in more detail.

As shown in FIG. 2, the Brand Ownership Scoring Module 110 includes a Brand Profile database 240 for storing profiles of selected brands, the Brand Profile database 240 comprising entries including computer readable instructions stored in a computer readable storage medium, e.g., hard drive, CR-ROM, DVD, non-volatile memory or another type of memory. A Brand Profile (BP) includes one or more entries, which define or are closely associated with a selected brand. The entries include terms, such as words and phrases, which include core names of the brand or trademarks of the brand. For example, the corporate brand “Toyota” may be associated with “Camry”, “Highlander”, “make things better”, “moving forward”, etc. , which are related or known to be part of “Toyota” lines of products.

In addition to words and phrases, the entries in the BP can include online properties that are owned by the organization or company, to which the brand is registered, and that are related to the brand. Defining these online properties entails adding the URLs (Uniform Resource Locators) that are owned by the company to the Brand Profile database 240. For example, www.toyota.ca and www.toyota.com are known to be official websites of Toyota.

The Brand Profile database 240 can be any commercial off-the shelf or proprietary database, which can be used to store profiles of selected brands.

A Search Engine Interface Unit 230 of the Brand Ownership Scoring Module 110 provides the interface to the set of search engines 180, to query the set of search engines 180 with the entries from the BP database 240, and to retrieve search results returned by the set of search engines 180. The search results are generally ranked according to some relevancy criteria defined in each search engine. Each search result has an origin site that can be associated with one of the categories of content sources as described above. Conveniently, the Search Engine Interface Unit 230 comprises computer readable instructions stored in a computer readable medium, which, when executed, cause a processor of a computer to perform various functions of the Search Engine interface Unit 230 as described above.

A Classification Engine 220 of the Brand Ownership Scoring Module 110 receives the search results retrieved by the Search Engine Interface 230 and classifies them according to their origin sites. The classification is performed by comparing the origin sites of the search results against the categories of content sources, and assigning each search result to a respective category of content sources. Conveniently, the Classification Engine 220 comprises a computer readable instructions stored in a computer readable medium, which, when executed, cause a processor of a computer to perform the classification of the search results as described above.

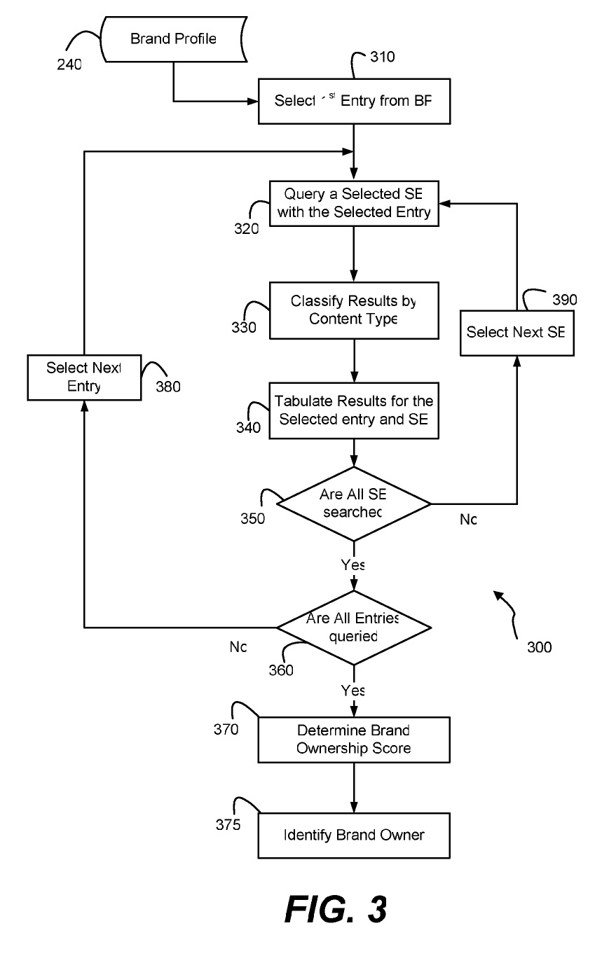

The Brand Ownership Score Calculation Engine 210 of the Brand Ownership Scoring Module 110 shown FIG. 2 applies a calculation method on the search results thus classified to determine a brand ownership score and the category of content sources having more impact on the selected brand. Conveniently, the Brand Ownership Score Calculation Engine 210 comprises computer readable instructions stored in a computer readable medium, which, when executed, cause a processor of a computer to apply a calculation method to the classified search results. Different calculation methods used by the Brand Ownership Score Calculation Engine 210 will be further detailed below with reference to FIG. 3.

As mentioned above, the Brand Ownership Scoring Module 110 can be implemented in one or more software modules comprises computer readable instructions stored in a computer readable storage medium and running on a hardware platform, for example, a general purpose or specialized computer, including a central processing unit (CPU), and a computer readable storage medium, e.g., a memory and other storage devices such as CD-ROM, DVD, hard disk drive, etc.

FIG. 3 shows a flowchart 300 illustrating a method for generating a measure of brand ownership and identifying a brand owner.

At step 310 of the flowchart 300, the method selects a first entry from the Brand Profile database 240, and then queries, at step 320, a selected search engine (SE) with the selected entry. At step 330, the search results are classified according to their origin site under corresponding category of content sources, i.e. as belonging to one of the following categories of content sources:
Brand-owned content 120;
Mainstream media content 130;
Social media content 150;
Spam content 160; and
Third-party content 140.

In one embodiment of the present invention, only the first L search results are considered. By way of example only and for the purpose of simplifying further explanations, L=10 will be considered for the rest of this application. The first 10 search results generally coincide, in most popular search engines, with the first page of the search results. Other values of L could very well be considered without departing from the principles of the present invention.

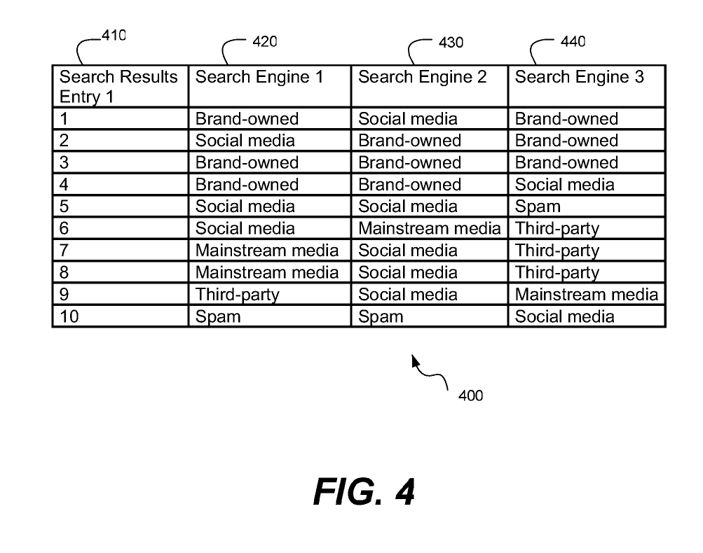

At step 340 of the flowchart 300, the search results thus classified are tabulated as shown in columns 410 and 420 of FIG. 4. Columns 410 and 420 show an exemplary set of results provided by the Search Engine 1, with Column 410 illustrating the search results for the Entry 1, and Column 420 illustrating the categories of content sources assigned to each search result returned by the Search Engine 1. Once the classified search results are tabulated, a check is performed to verify, at step 350, whether all Search Engines have been queried with the selected entry. If the result is NO (exit “No” from step 350), the next search engine is selected, at step 390. The selected entry is now used as a search term to query the newly selected search engine. Steps 320 to 350 are iterated until all search engines have been queried (exit YES from step 350). By way of example only, three search engines have been selected, and at the end of the iteration, the tabulated and classified search results are illustrated in the table 400 of FIG. 4 with regard to the three selected search engines. It is understood that another number of selected search engines may chosen as required.

At step 360, a test is performed to verify whether all entries have been used to search the search engines. If No (exit “No” from step 360), the next entry in the Brand Profile database 240 is selected at step 380, and steps 320 to 350 are repeated with the selected entry as the new search term for all the search engines.

If all entries have been queried (exit “Yes” from step 360), step 370 is invoked to determine the brand ownership score, and at step 375 the category of content sources having ownership of the selected brand is identified, thus completing the method 300.

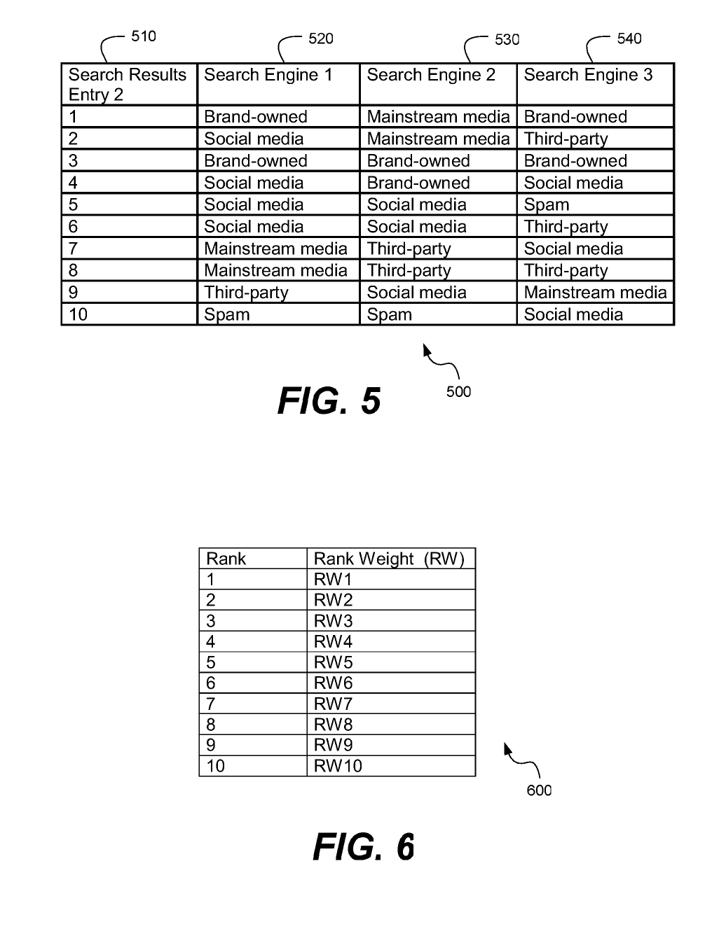

At the output of step 360, an exemplary classified search results for the second entry (considering only 2 entries in the Brand Profile database 240) is shown in table 500 of FIG. 5.

In the embodiments of the present invention, the brand ownership score determination of step 370, which is performed by the Brand Ownership Score Calculation Engine 210 of the Brand Ownership Scoring Module 110 can calculate the brand ownership score using different methods of calculation.

According to one method, the brand ownership score is expressed as an array of values, each representing a measure of impact of a category of content sources on the selected brand. Each category of content sources has a weight associated with it. Conveniently, the weight scale is from 0.00 to 1.0. Optionally, a user may alter the weights to best fit the importance of the categories of content, e.g., in accordance with the importance of lines of business of the user.

In this method of calculation, the impact for each category is calculated across all N search engines for the total number of entries (TotalNumberOfEntries) searched as follow:

Impact_Brand_Owned=[WeightBrand*100/(10*N)]* (#BrandOwned_SE_{—}1+ . . . +#BrandOwned_SE_N)/TotalNumberOfEntries;

with #BrandOwned_SE_K representing the number of search results from the K^{th} search engine classified as Brand-owned content and WeightBrand is the weight assigned to the category Brand-owned content;

Impact_Mainstream=[WeightMainstream*100/(10*N)]* (#MainstreamOwned_SE_{—}1+ . . . +#MainstreamOwned_SE_{—}1)/TotalNumberOfEntrie;

with # MainstreamOwned_SE_K representing the number of search results from the K^{th} search engine classified as Mainstream media content and WeightMainstream is the weight assigned to the category Mainstream media content;

Impact_SocialMedia=[WeightSocialMedia*100/(10*N)]* (#SociallyOwned_SE_{—}1+ . . . +SociallyOwned_SE_N)/TotalNumberOfEntries;

with # SociallyOwned_SE_K representing the number of search results from the K^{th} search engine classified as Social media content and WeightSocialMedia is the weight assigned to the category Social Media content;

Impact_Spam=[WeightSpam*100/(10*N)]* (#SpamOwned_SE_{—}1+ . . . +#SpamOwned_SE_N)/TotalNumberOfEntries;

with # SpamOwned_SE_K representing the number of search results from the K^{th} search engine classified as Spam content and WeightSpam is the weight assigned to the category Spam content;

Impact_ThirdParty=[WeightThirdParty*100/(10*N)]* (#ThirdPartyOwned_SE_{—}1+ . . . +#ThirdPartyOwned_SE_{—}1)/TotalNumberOfEntries

with #ThirdPartyOwned_SE_K representing the number of search results from the K^{th} search engine classified as Third Party content and WeightThirdParty is the weight assigned to the category Third-party content.

In this method of calculation, the step 375 of the flowchart 300 can readily identify the category of content sources, which has the ownership of the selected brand (Brand_Owner) by identifying the category of content sources with the highest value in the array representation of the brand ownership score i.e. Brand_Owner is the category corresponding to the

max (Impact_Brand_Owned, Impact_Mainstream, Impact_SocialMedia, Impact_Spam, Impact_ThirdParty);

with max( ) being the mathematical function that returns the element with the highest value in the argument.

Using the exemplary values on tables 400 and 500 of FIGS. 4 and 6 respectively, and the following exemplary unitary weights:

WeightBrand=1; WeightMainstream=1; WeightSocialMedia=1; WeightSpam=1; and WeightThirdParty=1;

the following numerical values can be estimated for all the categories of content sources:

Impact_Brand_Owned=(1*100/30)*(5+5+5)/2=25%

Impact_Mainstream=(1*100/30)*(5+3+2)/2=16.67%

Impact_SocialMedia=(1*100/30)*(6+8+5)/2=31.66%

Impact_Spam=(1*100/30)*(2+2+2)/2=10%

Impact_ThirdParty=(1*100/30)*(2+2+6)/2=16.67%

In this case, the category having the highest impact on the selected brand is the Social Media content.

In a modification to this method, a rank weight (RW) can be assigned to each search result according to its rank in the overall search results, as illustrated in FIG. 6. A search result ranked 5, for example, will be assigned RW5. Additionally, each search engine K may be assigned a weight SE_K_WEIGHT to account for the different level of popularity among search engines.

By adopting the rank weight and the search engine weight, and considering the exemplary search results for N=3 search engines and TotalNumberOfEntries=2 as provided in tables 400 and 500 of FIGS. 4 and 5 respectively, each impact can now be calculated as follow:

Impact_Brand_Owned=[WeightBrand*100/(3*SUM_RW)]* [SE_{—}1_WEIGHT*(RW1+RW3+RW4+RW1+RW3)+SE_{—}2_WEIGHT*(RW2+RW3+RW4+RW3+RW4)+SE_{—}3_WEIGHT*(RW1+RW2+RW3+RW1+RW3)]/2;

Impact_Mainstream=[WeightMainstream*100/(3*SUM_RW)]* [SE_{—}1_WEIGHT*(RW7+RW8+RW2+RW7+RW8)+SE_{—}2_WEIGHT*(RW6+RW1+RW2)+SE_{—}3_WEIGHT*(RW9+RW9)]/2;

Impact_SocialMedia=[WeightSocialMedia*100/(3*SUM_RW)]* [SE_{—}1_WEIGHT*(RW2+RW5+RW6+RW4+RW5+RW6)+SE_{—}2_WEIGHT*(RW1+RW5+RW7+RW8+RW9+RW5+RW6+RW9)+SE_{—}3_WEIGHT*(RW4+RW10+RW4+RW7+RW10)]/2;

Impact_Spam=[WeightSpam*100/(3*SUM_RW)]*[SE_{—}1_WEIGHT*(RW10+RW10)+SE_{—}2_WEIGHT*(RW10+RW10)+SE_{—}3_WEIGHT*(RW5+RW5)]/2;

Impact_ThirdParty=[WeightThirdParty*100/(3*SUM_RW)]* [SE_{—}1_WEIGHT*(RW9+RW9)+SE_{—}2_WEIGHT*(RW7+RW8)+SE_{—}3_WEIGHT*(RW6+RW7+RW8+RW2+RW6+RW9)]/2;

in which SUM_RW is the sum of all rank weights (RW1+ . . . +RW10).

From this array of values, the step 375 of the flowchart 300 can identify the category of content having the ownership of the selected brand by identifying the category of content with the highest impact value as discussed above.

In an alternative method, a brand ownership score for one Search Engine (Brand_Ownership_Score_{—}1_SE) is first calculated by applying a weight to each category of content sources according to the following formula:

$$Brand\_Ownership \_Score \_ 1 \_SE = ( {{WeightBrand}^{*} ( \# BrandOwned / 10 )}^{*} 100 ) + ( {{WeightMainstream}^{*} ( \# MainstreamOwned / 10 )}^{*} 100 ) + ( {{WeightSocialMedia}^{*} ( \# SociallyOwned / 10 )}^{*} 100 ) + ( {{WeightSpam}^{*} ( \# SpamOwned / 10 )}^{*} 100 ) + ( {{WeightThirdParty}^{*} ( \# ThirdPartyOwned / 10 )}^{*} 100 )$$

in which

#BrandOwned is the number of search results classified under the Brand-owned content category;

#MainstreamOwned is the number of search results classified under the Mainstream content category;

#SociallyOwned is the number of search results classified under the Social Media content category;

#SpamOwned is the number of search results classified under the Spam content category; and

#ThirdPartyOwned is the number of search results classified under the Third-part content category.

The brand ownership score across all Search Engines SE_1 to SE_N (Brand_Ownership_Score_SE_1 to_SE_N) is then determined by summing across all Search Engines as follows:

Brand_Ownership_Score_SE_{—}1_to_SE_N=(Brand_Ownership_Score_{—}1_SE_{—}1+Brand_Ownership_Score_{—}1_SE_{—}2+ . . . +Brand_Ownership_Score_{—}1_SE_N)*100/N

in which Brand_Ownership_Score_{—}1_SE_k is the brand ownership score for search engine k and N is the number of search engines.

The following illustrates an example of this equation, used against one search engine with exemplary values of:

$$[ BrandOwned = 5 {\% }^{*} WeightBrand = 10 \% + MainstreamOwned = 15 {\%}^{*} WeightMainstream = 20 \% + SocialMediaOwned = 70 {\%}^{*} WeightSocialMedia = 60 \% + SpamOwned = 2 {\%}^{*} WeightSpam = 5 \% + ThirdPartyOwned = 8 {\%}^{*} WeightThirdParty = 5 \% ] 100 / Number Of Engines = 1 ] = {[ .005 + .03 + .42 + .001 + .004 ]}^{*} 100 / 1 = {0.46}^{*} 100 / 1$$

$$Brand Ownership Score = 46$$

The brand ownership score can be stored in a time series, allowing for a trend analysis to be performed, determining how the brand ownership score changes and if more control is moving to communities for a particular brand, or if that control is moving to others, such as mainstream media.

In an alternative method of calculation, the number L of search results considered is extended over two or more pages, with each page having an assigned weight according to its level in the set of pages considered.

The embodiments of the present invention provided numerous advantages, most importantly, allowing public relation professionals to make preemptive marketing decisions that are not available today.

Thus, an improved method and system for determining a measure of various categories of media owners, e.g., social media, on a corporate brand have been provided.

What is claimed is:

1. A method for determining a brand ownership of a brand, the method comprising:
(a) generating a brand profile having one or more entries associated with the brand;
(b) querying one or more search engines with the one or more entries;
(c) retrieving a predetermined number of search results from each of said one or more search engines queried;
(d) classifying the search results by assigning each result to a category of content sources; and
(e) determining a brand ownership score of the selected brand based on said classified results.

2. The method of claim 1, wherein the step (a) comprises:
i) generating a list of terms associated with said brand;
ii) generating a list of content sources associated with said brand; and
iii) storing the list of terms and the list of content sources in a database.

3. The method of claim 1, wherein the step (e) further comprises representing the brand ownership score as an array of values, each value corresponding to an impact of a respective category of content sources on the brand.

4. The method of claim 3, wherein the impact of the respective category of content sources is determined by:
i) assigning a weight to the respective category of content sources;
ii) calculating a number of search results classified under the respective category of content sources; and
iii) determining the impact based on the assigned weight, a number of search results classified under the respective category of content sources, a total number of search engines queried, and a total number of entries in the brand profile.

5. The method of claim 3, wherein the impact of the respective category of content sources is determined by:
i) assigning a weight to the respective category of content sources;
ii) assigning a rank weight to each search result, classified under the respective category of content sources, the rank weight corresponding to a rank of the result; and
iii) determining the impact based on the assigned weight, the assigned rank weights, a total number of search engines queried, and a total number of entries in the brand profile.

6. The method of claim 3, wherein the impact of the respective category of content sources is determined by:
i) assigning a weight to the respective category of content sources;
ii) assigning a rank weight to each search result, classified under the respective category of content sources, the rank weight corresponding to a rank of the result;
iii) assigning a weight to each of said one or more search engines; and
iv) determining the impact based on the assigned weight, the assigned rank weights, a total number of search engines queried, a total number of entries in the brand profile, and the assigned weights of the one or more search engines.

7. The method of claim 4, further comprising identifying the category of content sources having ownership of the selected brand as the category of content sources having a highest value of the impact in the array of values.

8. The method of claim 1 wherein the category of content source is selected from the group consisting of: mainstream media content category, spam content category, social media content category, third-party content category and brand content category.

9. A method of determining a brand ownership of a brand, the method comprising:
(a) providing a brand profile for the brand, wherein the brand profile has one or more entries representing terms and content sources associated with the brand;
(b) querying one or more search engines with the one or more entries;
(c) for each of said one or more search engines queried, retrieving a predetermined number of search results, and classifying each search result under a category of content sources selected from the group consisting of: mainstream media content category, spam content category, social media content category, third-party content category and brand content category; and
(d) determining an impact value of each category of content sources on the selected brand based on a number of results classified under each respective category of content sources.

10. The method of claim 9, further comprising the step of identifying one category of content sources having a highest impact value on the ownership of the brand.

11. The method of claim 9, wherein the step (d) comprises:
i) assigning a weight to each category of content sources; and
ii) calculating the impact value based on the assigned weight, the number of search results classified under the respective category of content sources, a total number of search engines queried, and a total number of entries in the brand profile.

12. The method of claim 9, wherein the step (d) comprises:
i) assigning a weight to the respective category of content sources;
ii) assigning a rank weight to each search result classified under the respective category of content sources, the rank weight corresponding to the rank of the search result; and
iii) calculating the impact value based on the assigned weight, the assigned rank weights, a total number of search engines queried, and a total number of entries in the brand profile.

13. The method of claim 9, wherein the step (d) comprises:
i) assigning a weight to the respective category of content sources;
ii) assigning a rank weight to each search result classified under the respective category of content sources, the rank weight corresponding to the rank of the search result;
iii) assigning a weight to each of said one or more search engines; and
iv) calculating the impact value based on the assigned weight, the assigned rank weights, a total number of search engines queried, a total number of entries in the brand profile, and the assigned weights of the one or more search engines.

14. A computer system for determining a brand ownership, comprising:
a database, stored in a computer readable medium, for storing a profile of a brand, the database having one or more entries associated with the brand;
a computer, having a processor and a computer readable storage medium storing computer readable instructions for execution by the processor, to form the following modules:
a search engine interface for launching searches to one or more search engines using the one or more entries as search terms and retrieving search results returned by the one or more search engines;
a classification engine for classifying the search results retrieved by the search engine interface into a category of content sources; and
a brand ownership score calculation engine for determining a brand ownership score and identifying a category of content sources as having ownership of the brand based on the brand ownership score.

15. The system of claim 14, wherein each search result is classified under a category of content sources selected from the group consisting of: mainstream media content category, spam content category, social media content category, third-party content category and brand content category;

16. The system of claim 14, wherein the one or more entries of the database comprises a list of one or more terms associated with the brand, and a list of one or more content sources associated with the brand.

17. The system of claim 14, wherein the brand ownership score is an array of impact values, each impact value corresponding to a measure of impact of a respective category of content sources.

18. The system of claim 17, wherein each impact value of the respective category of content sources is calculated based on a weight associated to the respective category of content sources, and on a number of search results classified under the respective category of content sources.

19. The system of claim 17, wherein each impact value of the respective category of content sources is calculated based on a weight associated to the respective category of content sources, on a number of search results classified under the respective category of content sources, and on respective rank weights assigned to each of said search results.

20. The system of claim 17, wherein each impact value of the respective category of content sources is calculated based on a weight associated to said respective category of content sources, on a number of search results classified under the respective category of content sources, on respective rank weights assigned to each of said search results, and on respective weights assigned to said one or more search engines.

21. A computer readable medium, comprising a computer code instructions stored thereon, which, when executed by a computer, perform the steps of the method of claim 1.
